(19) United States
(12) Patent Application Publication
(10) Pub. No.: US 2004/0194033 A1
(43) Pub. Date: Sep. 30, 2004

(54) Late binding of stamped page content in a production document workflow

(76) Inventors: Robert K. Holzwarth, Palmyra, NY (US); Karl Heinz Kremer, Rochester, NY (US); Karl R. Schultz, Hilton, NY (US)

Correspondence Address: Richard A. Romanchik, Heidelberg Digital L.L.C., 2600 Manitou Road, Rochester, NY, 14624, US

(21) Appl. No.: 10/790,534

(22) Filed: Mar. 1, 2004

Related U.S. Application Data
(60) Provisional application No. 60/459,247, filed on Mar. 31, 2003.

(51) Int. Cl. G06F 17/21; G06F 15/00

(52) U.S. Cl. 715/530

(57) ABSTRACT

A flexible process for printing content on designated pages wherein, content is placed on designated pages of a document by the inclusion of a flag, tag, marker or variable early in the workflow process to indicate those pages are going to contain a specific content type. The invention provides information to place content on pages early in the production workflow process by placement of flags, tags, markers or variables in the form of computer readable indicia that can readily be identified by a program module to perform the late binding of the content late in the printing stage.

### RELATED APPLICATIONS

This application claims the priority date of U.S. Provisional Application Serial. No. 60/459,247 filed Mar. 31, 2003 entitled “LATE BINDING OF STAMPED PAGE CONTENT IN A PRODUCTION DOCUMENT WORKFLOW”.

### FIELD OF THE INVENTION

The present invention relates to controlling the content on pages and more particularly, to controlling the workflow process to restrict the placing of content into a virtual form until it is time to actually render the page.

### BACKGROUND OF THE INVENTION

The ImageSmart™ Document Mastering software product from Heidelberg Digital L.L.C., in Rochester, N.Y., is used for preparing documents for printing in a high-volume print production environment. The ImageSmart™ Document Mastering product, works in conjunction with Adobe Acrobat®, made by Adobe Systems Inc., in Sunnyvale Calif. Accordingly, ImageSmart™ employs a PDF workflow. Adobe Acrobat® has a software development kit and an application programming interface API that allows the creation of plug-ins for Acrobat® which can programmatically extend its programming functionality. This provides the ImageSmart™ Document Mastering software with a number of hooks into Adobe Acrobat® allowing notification regarding data and events. In essence, ImageSmart™ allows the user to function as if they were using Adobe Acrobat®. The plug-ins for Acrobat® are typically written in C++, which is a very popular programming language.

Currently off-the-shelf Adobe Acrobat® plug-ins can be included with the ImageSmart™ document mastering system, such as Quite Imposing Plus™ made by Quite Software, and StampPDF®. These plug-ins provide a variety of uses and each allows the addition of page numbers to the document. Still, these plug-ins have drawbacks. StampPDF®, effectively creates a stamp on a page and reduces the ability to modify a document. The term “stamped” then refers to the situation wherein a page number or other mark is applied to a page, and in most cases is irrevocable. Once a page number is stamped onto a page using StampPDF®, it is not possible to change the page number. It is desirable to have the ability to dynamically change page numbers in order to have the capability to include various types of media, such as tab stock, or other forms of pre-collated media within a print job and still produce the print job in an efficient manner. It is not desirable to preclude changing page numbers because the page number has, irreversibly, become part of the page. Acrobat® plug-ins, such as StampPDF®, effectively create a page number that is stamped on a page without providing any intelligence surrounding the page number. For example, if the third page of a document is stamped with a page number such as “page 3”, and the second page is later removed, “page 3” still remains on the page that was previously stamped as the third page but which now is the second page. StampPDF® marks the page number on a page thereby creating a static stamp. Quite Imposing Plus™ also allows stamps of page numbers onto a page. Other programs, such as Microsoft Word™, do not generate the final page numbers until the document is actually sent to the printer.

A shortcoming within the prior art is the lack of control over page numbers using currently available software packages. Users of print production systems desire better control over page numbers and they commonly request such a feature within production printing. The desire for better control over page numbering schemes arises from the necessity to add pages of different media types to documents without ruining the page numbering scheme. Documents are commonly pulled together from a variety of sources (a process known as a “repurposing” the document content). The tools that currently exist for the purpose of bringing pages together frequently cause a conflict in the page numbering scheme. Typically, the old page numbers are electronically deleted or covered up by some other means such as the use of “stick on masking tape” (From Quite Software Inc.). When the new page numbers are applied across the entire document, there are often conflicts in the page numbering scheme. The ImageSmart™ Document Mastering solution has previously offered methods of page numbering. The problem is that in all cases, the page numbers are “static” or “stamps”. Once page numbers were applied, they could not easily be changed upon the addition of new pages to a document. Further, a production print job commonly will have pages (such as those to be printed on tab stock) that should not receive page numbers. Current products offer no solutions to these problems. The same problems exist for other forms of stamps, such headers, footers and watermarks.

Other problems with numbering become evident during merging of documents. One source of problems is the possibility that two documents will have different formats. The prior art solutions currently available do not provide the ability to recognize the dynamic content within these different documents and alert the user where the formats are in conflict or are different. Many of these prior solutions destroy the page specific content of a page that is taken from one document and placed into another document. An example of a prior art solution that uses global attributes, is DigiPath®. DigiPath® uses Tagged Image File Format (“TIFF”) files to actually print the page number once a page is ready to be printed out. Systems employing DigiPath® lose their page specific information for pages that are taken from one document and placed in another document. The placing of text or graphics on a page using a tiff format for all intents and purposes locks them into place and “burns” them onto the page. The use of TIFF files by DigiPath® results in a lack of portability. Typically, systems employing DigiPath® use an external file to track information regarding the print job. Therefore, if a page is moved to a different document, that page will be given the global attributes of the new document.

DigiPath® does provide the capability for recognizing tab page stock. In printing using tab stock there are two overall considerations. First, tab stock may extend beyond the boundaries of the other paper that is used in the document. It is the tab that is the portion of the tab stock to be printed on. Secondly, it has to be determined at what times during printing the tab stock is inserted into the document. Most commonly, the pages of tab stock that are inserted to document do not receive page numbers. If the tab stock does not receive a page number then the tab stock also does not consume a page number. This can result in undesirable circumstances such as incorrect page numbering or a lack in capability to alter page numbers as previously described. DigiPath® software operates in such a manner and suffers from these shortcomings. The DocuTech® hardware platform uses DigiPath® as its front end software. DigiPath® is automatically set up to not allow page numbering of tab stock.

Other existing solutions, such as StampPDF or Quite Imposing Plus™, cannot recognize tab stock or different types of media. For example Quite Imposing Plus™ allows the designation of a range of pages that will receive page numbers. The user can specify start number and a range of pages that will receive page numbers. Therefore, using Quite Imposing Plus™, if a document has 100 pages with 10 tab inserts, the user would typically be required to specify up to 11 ranges of pages for page numbering purposes.

Prior art solutions for book style page numbers allow the user to designate the placement of page numbers for a set of pages. Quite Imposing Plus™ provides one such solution, wherein all the odd pages have the page number placed on the lower right side of the page. Then, user must designate that for all the even pages, the page number will be on the lower left. This two-step process is inherently difficult and cumbersome. However, there is a more substantial problem that occurs if a different type of media is inserted into the document and that media does not receive a page number. This could create a situation that throws off the entire page numbering scheme using Quite Imposing Plus™. This is especially true in cases where the inserted media has a single side that is to be printed on, and, therefore, counts as a page. For example, in books with chapters (or sections) having pages that are being printed in duplex followed by pieces of tab stock that are used as a front page for every chapter (or section), that piece of tab stock or a bleed tab will typically consume a page number and count as a page. This creates a situation where the page number for what should be an even numbered page is printed on the front side instead of the back side where even numbered pages normally have their page numbers. Therefore, the tab stock and all subsequent pages will have their page numbers printed on the bound edge of the page (the opposite of the intent). The prior art does not provide any solution for this problem. Additionally, the situation previously discussed using tab stock can exist whether or not the tab stock is printed and consumes a page number.

### BRIEF DESCRIPTION OF THE DRAWINGS

FIG. 1 is a flow diagram for a printing production workflow;

FIG. 2 is a flow diagram illustrating workflow functionality;

FIG. 3 is a diagram illustrating a split pane screen envisioned by the invention to enter computer readable indicia into an electronic version of a document;

FIG. 4a is a diagram illustrating conventional page number creation techniques;

FIG. 4b is a diagram illustrating the late binding page numbering techniques of the invention.

### DETAILED DESCRIPTION OF THE INVENTION

The present invention provides flexibility in the process of printing the page numbers on the pages of a document by the including of a flag, tag, marker or variable that indicates which pages are going to contain a page number. Additionally, the invention provides flexibility for adding content information that is desired to be placed on the rendered page.

The term “late binding”, as used within this disclosure, refers to the circumstance where a specific page number is not applied to a page until late in the workflow, typically not until that page it is ready to be printed. Prior the application of a specific page number, a variable will be used to represent the page number.

The term “page content in a production document workflow” in this disclosure refers to the fact that the present disclosure is not restricted to just page numbers, and may extend to other areas. The meaning of page content as discussed herein, generally refers to page numbers, however, the concepts of present disclosure can be extended to virtually any type of content. Therefore, the preferred embodiments that discuss the desirability of using a variable to represent the page numbers rather than a bitmap stamp, should not preclude interpretation of the present invention that can include any type of the content.

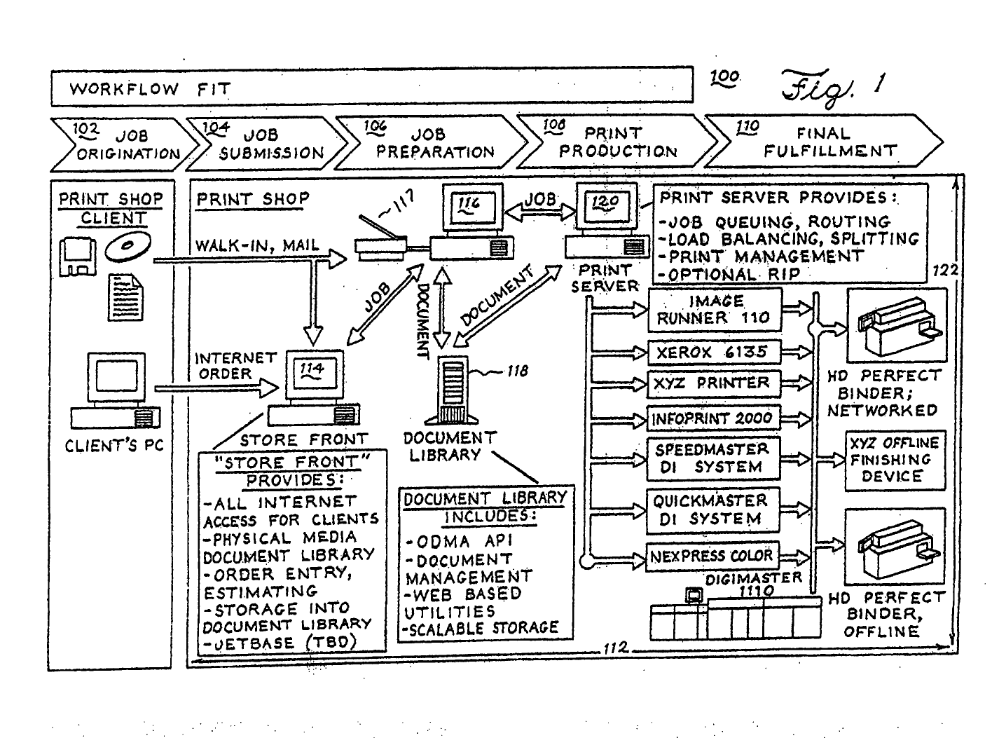

Referring now to FIG. 1, there is a flow diagram for a production workflow 100 in a production print shop employing a commercial high-volume copy or printing device of the type envisioned by the preferred embodiments of the invention. A workflow as defined herein, refers to the tasks, procedural steps, organizations and people generally required to perform the workflow 100 and run the print shop. A workflow approach to analyzing and managing a business or process, such as production printing can be combined with an object oriented approach, which tends to focus on the discrete objects and processes involved such as documents, pages, data and databases. For the purposes of this disclosure, the term “object oriented”, as used herein, should not be construed so narrowly such that an object-oriented programming approach is the only method of implementation of the disclosed embodiments. Numerous variations on specific implementations will be readily apparent to those skilled in the art.

In the print shop, network 112 contains computer workstations 114, 116, servers 118, 120 and high volume output devices 122. The servers 118, 120 include network servers 118 and print servers 120. The topology of the network 112 is typically structured so as to align with the workflow 100 of the print shop. The network 112 may be implemented as a wired or wireless Ethernet network or other form or local area network. Further, the network 112 may include wired or wireless connections to wide area networks such as the Internet and connections to other local area networks such as though a virtual private network.

The workflow 100 includes the procedural stages of job origination 102, job submission 104, job preparation 106, print production 108 and final fulfillment 110. Alternatively, one or more of these procedural stages may be combined with other additional procedural stages. Job origination 102 is the procedural stage of receiving the documents and instructions, which together are defined as a “job”, from the customer. Job origination 102 can occur when a customer physically brings his job, whether in hard copy or electronic form, to the print shop or otherwise transmits the job to the print shop, whether by phone, fax, postal mail, electronic mail or over a local area or wide area network such as over the Internet. It should be noted that a job can contain more than one document and more than one set of instructions. For example, a job could contain many documents, each being one chapter of a book, along with a document containing a cover for the book. This exemplary job may include the instructions for producing the body of the book from the individual chapter documents and another set of instructions for producing the cover. In addition, as will be discussed below, there could be a third set of instructions for assembling the cover to the body of the book.

Job submission 104 comprises the receipt of a print job by the print shop combined with the entering of the job into the print shop's system or workflow. Typically, the instructions from the customer will be written down on a special form, referred to herein as a “ticket” or “job ticket”. A job ticket can also be electronically created and maintained. Furthermore, pre-defined job tickets may be available that employ standardized instructions. For example, the shop could provide printed job tickets that contain parameters that are commonly requested by customers in order to save time. For example, a pad of pre-printed job tickets with the instructions to duplicate the documents, three-hole punch the final output and assemble the punched final output in a three ring binder. In very simple print shops, job submission 104 may simply be the receiving of the original documents and instructions along with the creation of a ticket, placing the job in a paper folder and setting it in a physical queue for later handling in subsequent procedural stages. However, numerous print shops have the capability to except print jobs electronically, in which case job submission 104 takes the form of an electronic version of the document that is entered, usually using an electronic job ticket, into the shops electronic production system. To electronically submit documents that are brought in to the print shop in hard copy form, the hard copy of the document must first be scanned electronically so that it can be submitted as an electronic version of the document into the shop's computer system. Once this electronic version of the document is loaded on the shop's computer system, the electronic version of the document is typically converted into a document format that the production system uses (such as PDF).

For job submission stage 104, computer network 112 can include one or more “store front” workstations 114 at the order taking desk. These workstations 114 are used for the job submission stage 104 and typically are configured to handle many different electronic media and can also be configured to receive jobs over the Internet or other forms of network connections with customers. Furthermore, these workstations 114 are typically configured to read many different electronic file formats such as those used by the Microsoft Office™ family of products manufactured by Microsoft Corporation, located in Redmond, Wash., or various other desktop publishing program file formats such as Adobe Pagemaker™, Adobe In Design® or Quark Express™. In addition, these workstations 114 can also read “ready for printer” file formats, which will be discussed later, such as Portable Document Format™ (“PDF”), Postscript™ (“PS”) or printer control language (“PCL”). Job preparation workstations 114 can also accept image formats such as TIFF, bitmap (“BMP”) and PCX. These workstations 114 can also include a scanner 117 for scanning hard copies of documents into the computer system. The store front workstations 114 typically have the ability to generate a job ticket, electronically or in hard copy form, for the print job containing all of the instructions for completing the production printing task.

As an example of job submission 104, a customer might bring in two different documents, one being the body of a book and the other being the photographs to be inserted at specific pages. The customer may then instruct that the photographs be inserted at particular pages and that the final assembly has continuous page numbers added. The body of the book may be in Microsoft Word™ format while the images of the photographs are in Adobe Photoshop® format. While the operator could figure out at which pages the images will be inserted and appropriately number the pages of the book and photographs using each individual software package, this is a very complex and time-consuming process considering the shortcomings within prior art systems. It also requires that the operator be trained and familiar with a range of prior art software packages and runs the risk that he will not be familiar with the particular package that the customer used. Therefore, it is more efficient to convert each of the various file formats into a unified format that allows the operator to prepare the job using a single software interface. In the preferred embodiments, all documents, whether provided in hard copy or electronically, are distilled or converted into a print ready file format, preferably, the Portable Document™ developed by Adobe Systems Inc., located in San Jose, Calif.

A ready for printer file format is defined, herein, as a file format which contains both the data to be printed along with printer control instructions that can be directly interpreted by the internal processing engine of a printer or other form of hard copy output device in order to rasterize the image data onto the output media. Rasterization is the placement of image data at a specific location on the output media. Such file formats include Portable Document Format™ (“PDF”) and Postscript™ (“PS”) which are both manufactured by Adobe Systems Inc., located in San Jose, Calif., as well as printer control language (“PCL”), manufactured by Hewlett Packard, located in Palo Alto, Calif. Examples of non-ready for printer formats include the native application file formats for personal computer application programs such as Microsoft Word™. These file formats must be first converted to a ready for printer file format before they can be printed. Furthermore, some image file formats, such as the TIFF contain, or use, “bitmap” image data that is already in a format that specifies image location on the output media. TIFF files do not contain printer control instructions for interpretation by the internal processing engine of the printer and therefore, for the purposes of this disclosure, TIFF is not a ready for printer file format. By using a ready for printer format, rasterization of the image data can be delayed as close as possible to the final placement of the image data on the output media. This allows the most efficient use of the production print device 122 by allowing its internal control logic to optimize the rasterization process resulting in output that is more likely to match with the customer's expectations.

For the job preparation stage 106, the production printing workflow 100 includes job preparation workstation 116 coupled with scanners 117 and network servers 118 coupled with the storefront workstations 114 over the network 112. Herein, the phrase “coupled with” is defined to mean directly connected to or indirectly connected with through one or more intermediate components. Such intermediate components may include both hardware and software based components. The job preparation stations 116 preferably execute workflow management software, described in more detail below, which allows the operator to manage, edit and print jobs. The network server(s) 118 may include a document library which allows manipulation, management, storage and archiving of jobs, or their respective documents and/or tickets, as well as facilitates and manages the flow of jobs from the store front computers 114 to the job preparation stations 116 and from the job preparation stations 116 to the print servers 120 or the production output devices 122. Exemplary document libraries include DocSmart™ document management system manufactured by MosaicSoft, Inc. located in Laguna Hills, Calif., Intra.Doc™ document management system manufactured by Intranet Solutions, Inc., located in Eden Prairie, Minn. and the DOCFusion™ document management system manufactured by Hummingbird, Inc., located in York, Ontario, Canada. In the preferred embodiment, the job preparation stations 116 are Imagesmart™ Workstations, manufactured by Heidelberg Digital, L.L.C., located in Rochester, N.Y. Alternatively, one may use an appropriate computer hardware platform such as one with the processing capabilities of a Pentium™ class processor, manufactured by Intel Corporation, located in Santa Clara, Calif., 64 megabytes of RAM or more, a 20 gigabyte hard disk or larger and appropriate display device. Further, in the preferred embodiment, the network servers 118 preferably comply with the Open Document Management Architecture (“ODMA”) standard and provide document management capabilities and scaleable storage.

The job preparation workstations 116 also provide the capability of the print shop to add value to the print production process by offering services to the customer. Such services include the ability to modify documents provided by the customer to add features that the customer could not or would not add himself. Such features include adding page numbers across multiple documents, Bates numbering, adjusting page layout for tab stock and aligning the output to account for binding. Further, the job preparation stations 116 provide the capability to fix errors in the documents such as removing artifacts in scanned images and masking over unwanted text or markings. The job preparation stations 116 can also be used to prevent inaccuracies in the finished output caused by the printing or binding process. Such inaccuracies include binder's creep, which happens after a document is imposed into a booklet/pamphlet using a signature imposition. Binder's creep occurs when the placement of the images on the paper fails to account for the thickness of the binding as a function of the number of pages in the book causing the image on the pages to shift inward as you get closer to the cover. Binder's creep can be prevented by shifting the image slightly while performing the signature imposition on the document. In addition, the job preparation station 116 allows the operator to manage and layout the document pages for final output, also known as “imposition” and “signature imposition”. In addition, the operator can shuffle pages, reverse pages, insert blank pages, trim and shift pages, create bleeds and place multiple pages on a sheet also known as “n-up” to create proof sets, brochures or pamphlets, etc. Furthermore, the job preparation station 116 permits the operator to add annotations to the document such as Bates numbers, page numbers, logos and watermarks. All of these services add value to the final output.

The next stage in the print production workflow 100 is the print production stage 108. In the print production stage 108, documents in final form for printing are sent to a print server 120 which will distribute the job to the final output device 122. In manual print shops, this stage 108 would be similar to an operator manually taking the ready for production job over to the desired output device 122 to start the job. The print production stage 108 manages the output resources of the print shop. Such management includes queuing jobs to the proper devices 122 in the shop, routing jobs to available devices 122, balancing the load placed on the various devices 122, and pre-processing jobs, such as splitting or RIP'ing the job, prior to sending it to a particular device 122. RIP stands for Raster Image Processor and is the hardware and/or software that converts ready for printer data into raster images. It is also a common term for rasterizing a page image onto the output media.

The print server 120 used in the print production stage 108 is coupled with the job preparation stations 116 and the network server 118 over the network 112. Further, the print server 120 is coupled with the various output devices 122 in the print shop. It should be noted that certain output devices 122 might not support electronic transfer of the data to be output and require a manual step for operation. Such devices would typically include a special binding machine that requires that the partially finished documents be manually transferred to the binding machine to complete the production. The print server 120 is preferably implemented as a separate computer coupled with the network 112, however, software based print servers running on a network server 118, job preparation station 116, output device 122 or store front workstation 114 may also be used. In the preferred embodiment, the printer server 120 includes an independent computer workstation, typically running a UNIX or Windows NT operating system, a software print server engine and a software print server application. The print server application offers the user an interface ability to configure and manage the print server operation. The print server engine performs the automated processes of the print server. These processes include spooling and queuing jobs and job content (i.e. the document), directing the jobs to specific production output devices based on the attributes of the print job and how these attributes are satisfied by the print engine, load balancing jobs among the various production output devices to keep all printers fully utilized, e.g. to split color from black and white jobs, and acting as a communication gateway where it can accept multiple input communication and print protocols translating them to the communication and print protocol the production output device 122 understands.

The final stage of the production printing workflow 100 is the final fulfillment stage 110. The final fulfillment stage 110 is the stage where the finished output is produced on the production output device 122. A production output device is a computer output device, such as a printer, designed for high volume production of printed documents. Such devices preferably include the ability to produce large quantities of documents with mixed media types and various degrees of finishing, such as stapling or binding, at very high speed. Exemplary printers include the Digimaster™, which is a Digital High Volume Printer manufactured by Heidelberg Digital, L.L.C., located in Rochester, N.Y. and the NexPress™ 2100 Color Printing Press manufactured by NexPress Solutions L.L.C., located in Rochester, N.Y.

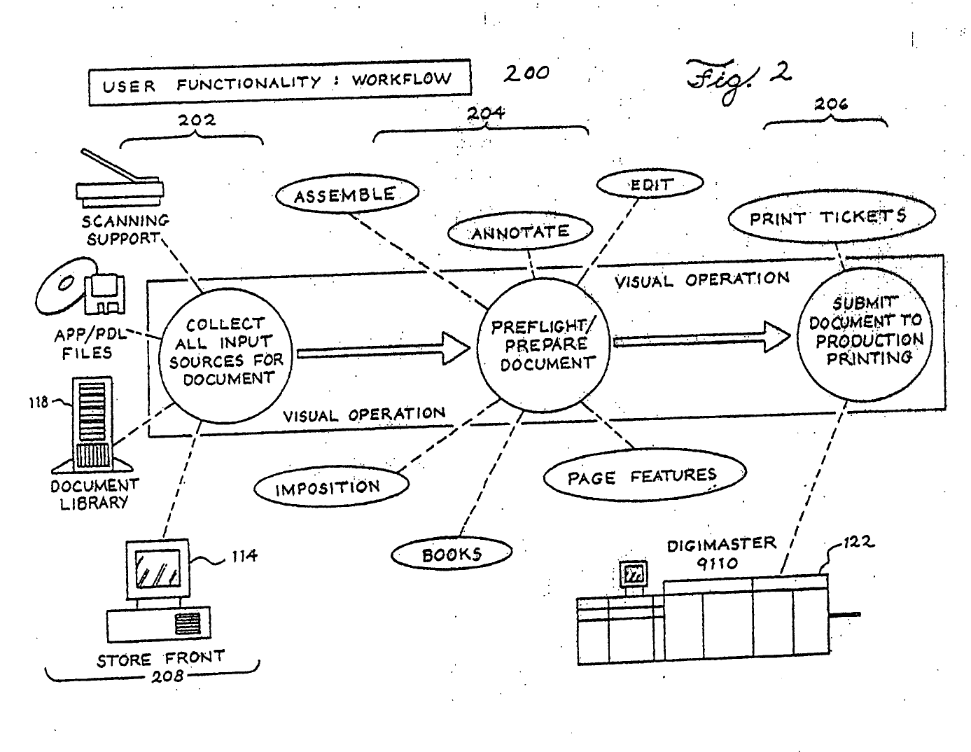

Referring now to FIG. 2, a flow diagram illustrating the user functionality workflow 200 of the preferred embodiment for the job submission and preparation stages 104, 106. The user workflow 200 includes an input source stage 202, a preflight stage 204 and a production stage 206. In the input source stage 202, all of the documents of the job are collected together from the different input sources 208. As previously discussed, the collected documents are preferably converted to a ready for printer format using a Portable Document Format™. For example, a special directory can be created on the network server 118 where data files in various file formats can be placed, for example, by the clerk who accepts the documents from the customer and inputs them into the store front workstation 114. Automated logic, which watches this directory, will see the placement of files and automatically convert them (or flag them for manual conversion) into a ready for printer format. Any documents that the automated logic cannot handle can be flagged for manual conversion. The converted documents are then passed to preflight stage 204 where they are prepared for production. This transfer of converted documents can occur by moving the documents to a special directory on the network server 118 where they can be accessed by the job preparation stations 116 or by transmitting the documents to the job preparation station 116. This process can be manual or automated and may involve placing the documents in a queue of documents waiting to be prepared for production. Further, this process could include a manual or automated determination of the capabilities, skill level or training level of the various operators currently logged into the available job preparation stations 116 as well as the current load/backlog of job in their respective queues. Taking these factors into account, the job can be automatically or manually routed to the operator best able to handle the job both technically and in an expedient manner.

In the preflight stage 204, the documents can be assembled, such as in a book, annotated, edited, imposed, or have page features applied. Once the documents are prepared for production, they are passed to the production stage 206. In the production stage 206, the prepared documents along with the production instructions (from the job tickets) are submitted to the print server or directly to the production output device 122 using a file downloader such as the ImageSmart™ Document Mastering Direct Print application program manufactured by Heidelberg Digital, L.L.C., located in Rochester, N.Y. This user functionality workflow 116 may be implemented as a combination of hardware, software and manually executed components and may involve one or more of the components detailed in the production printing workflow above.

The workflow is preferably implemented as a workflow management software program and interface executing on the job preparation workstation 116. The preferred workflow management software is visually oriented using an object oriented graphic user interface (“GUI”) approach that integrates control of the workflow functionality in a single interface. While the visual and operational appearance of the management software is object oriented, the implementation of the software can be any object oriented programming language or a non-object oriented programming language known in the art.

In the GUI interface, documents, job tickets and other entities and operations (collectively “objects”) are visually represented on the workstation 116 display, such as with icons, tree structures and pull-down menus, and may be interacted with using known devices and methods such as utilizing a keyboard, a mouse or a track ball to control a visually represented pointing device which is then used to click, select, drag and drop the displayed representations. Such manipulation of the visual representations results in manipulation of the underlying objects (documents, tickets, and other entities and operations). Furthermore, the GUI also permits creation and manipulation of relationships and associations among the various objects and visually displays such relationships and associations. Relationships and associations may be displayed, for example, using a hierarchical approach like a tree structure or file folder structure or using some alternate form of visual indication. It will be appreciated that graphic user interfaces are well known in the art and that numerous software development packages are available, which can be used to develop a GUI. One such package is the Microsoft Foundation Class (MFC) available from Microsoft Corporation, located in Redmond, Wash.

Further, the preferred GUI utilizes a document centric approach, thus providing a centralized viewing window for reviewing documents that are being worked on. In the preferred embodiment document viewing functionality is provided by the Adobe Acrobat software program, manufactured by Adobe Systems, Inc., located in San Jose, Calif.

As was noted above, the workflow management software integrates applications that implement, control or manage the stages of the production printing workflow 100. These applications include inputting documents from various sources, document assembly including the creation and manipulation of books, document editing, document annotation, document library access on the network server 118, setting and manipulation of page features, creation and manipulation of job tickets and printing.

The workflow management software is capable of receiving input from various different sources. Such sources include hard copy originals input via a scanner, native application formats such as the Microsoft Office™ Product suite and desktop publishing applications such as Quark Xpress™, manufactured by Quark. Inc., located in Denver, Colo. and FrameMaker™, manufactured by Adobe Systems, Inc., located in San Jose, Calif. The software can also accept TIFF documents as well as documents already in a ready for printer format. For hard copy input via a scanner, the software supports industry standard scanner interfaces, TWAIN, as defined by the TWAIN group located in Boulder Creek, Calif. Using these standard interfaces, the workflow management software receives the scanned image data directly in the ready for printer format. An exemplary scanner for use with the preferred workflow software is the Imagedirect™ Scanner manufactured by Heidelberg Digital, L.L.C., located in Rochester, N.Y.

Once documents are loaded into the workflow management software, tools are provided to perform value added services and prepare the documents for production. Assembly is the process of arranging or rearranging pages or adding or removing pages within a document. Assembly also includes imposition where page positions are forced such as when the first page of a chapter is forced to the front side of the paper. The workflow management software provides cut, copy, and paste and move functionality operable on one or more pages. This functionality is preferably implemented via pull-down menus, pop up dialog boxes or on screen option palettes or buttons as provide by the graphic user interface. In addition, the results of the respective operations are shown in a visual representation of the document in the centralized document-viewing window on the display for the job preparation station 116.

The workflow management software further provides support for editing and annotating the document. Tools are provided for image object area editing of a scanned page including erase (inside and outside) an area, cut, move, copy and paste area, as well as pencil erase. Page editing tools are also provided for editing on one or more pages including area masking and cropping. Tools are also provided for annotating documents, including alpha numeric and graphic annotations. Exemplary annotations would include page numbering and Bates stamping. The tools further provide for placing images behind the document content, also known as watermarking. Annotation can be performed on any portion of one or more pages. Properties of alpha numeric annotations, such as font size and style, are controllable. In all cases, the results of the respective operations are illustrated in the centralized document viewing window on the display for the job preparation station 116. In the preferred embodiments, edits or annotations can be created or manipulated by pointing to a visual representation of the document and/or pages within the document and selecting, dragging, dropping or clicking the representation and/or selecting from a menu of options, where the selection of a particular option causes the associated edit or annotation to be applied to the specified portions of the document. Alternatively, a palette of options may be displayed from which the user may choose an option to apply to selected portions of the document. Further, the interface may provide for a dialog box or other visual control for inputting control values for the edit or annotation such as the starting number of a Bates range. The workflow management software preferably provides further support for compound documents that are documents comprised of one or more other documents, such as books comprised of chapters or course packs comprised of one or more excerpted sources. Compound documents take advantage of the object oriented nature of the workflow management software. A compound document is a collection of one or more documents that have a particular ordering to them such as the chapters of a book The Compound Document further contains an automatically generated assembled document which is a single document containing the whole assembled Compound Document. Tools are provided which allow simple management of the documents of a Compound Document, assembly and updating of the documents into the assembled document and selective document manipulation, such as selective printing, of the documents within the Compound Document. Tools are also provided which can interpret the content of the documents within the Compound Document and automatically generate a table of tabs in the assembled document A compound document otherwise acts just like a document and can be edited, annotated, etc. and have tickets associated with it. Further, a compound document can contain other compound documents such as in the case of a multi-volume book. The individual documents and compound documents within the compound document further retain their independent existence and can be edited or printed independently of the Compound Document and shared with other Compound Documents with those edits being either automatically or manually updated into the assembled document within a particular Compound Document The workflow management software further displays a visual representation, such as with a hierarchical or tree structure, showing the compound document and any associated documents and tickets. In the preferred embodiments, compound documents can be created or manipulated by pointing to the visual representations of one or more documents and/or a visual representation of a Compound Document and selecting, dragging, dropping or clicking and/or selecting from a menu of options, where the selection of a particular option causes the associated feature to be applied to the selected documents or compound documents. Alternatively, a palette of options may be displayed from which the user may choose an option to apply to selected compound documents. Further, the interface may provide for a dialog box or other visual control for inputting control values for the compound documents such as margin values. For example, a user may select one or more documents and then choose a create Compound Document option from a pull down menu. The workflow software then creates a visual representation of the Compound Document on the display showing the association of the compound document to the selected documents. Alternatively, the user may first create a visual representation of a Compound Document and then drag and drop the visual representations of one or more documents onto the Compound Document visual representation. The workflow software then creates the appropriate logical associations of the data for which the visual representations represent.

The workflow management software is also preferably programmed with data about the different production output devices 122 in the print shop or otherwise available and their capabilities or other equipment, such as finishing equipment, which can be utilized either automatically or manually. The software provides tools which allow the operator to set page features/formatting which are made possible by those specific capabilities. Such page features include: the plex of the document such as duplex or simplex (double sided or single sided output); binding options; such as stapling or hole punching; and the availability and control settings for handling tab stock or ordered media. The preferred embodiments preferably support all of the features of the Digimaster™ line of high volume digital printers manufactured by Heidelberg Digital, L.L.C. located in Rochester, N.Y. In the preferred embodiments, these page features can be set by selecting or pointing to a visual representation of one or more pages and selecting from a menu of options, where the selection of a particular option causes the associated feature to be applied to the selected pages. Alternatively, a palette of options may be displayed from which the user may choose an option to apply to selected pages. Furthermore, the interface may provide for a dialog box or other visual control for inputting control values for the feature such as the type of tab stock. Setting page features for specific pages encodes instructions to the production output device 122 for implementing those features within the ready for “printer-formatted” file. When the production output device 122 receives the file for printing, it will interpret those instructions to implement the desired feature. For page features that the current device 122 cannot handle, the device 122 can signal the operator that manual intervention is required and direct the operator through the appropriate steps to implement the page feature and complete the job. This may include instructing the operator to remove partially finished documents and transfer them to a binding machine for finishing or instructing the operator to load a specific media type or tab stock into the device 122.

Tools are further provided by the workflow management software to support electronic versions of tickets for specifying production output device instructions and parameters, as well as other finishing steps which may or may not be automated, which are global to the document, e.g. job level features or global document attributes. These include such attributes as the general media type or color to use and the method of binding such as stapling. Tickets, also referred to as print tickets or job tickets, can exist independently of documents or compound documents as was mentioned above. They are independently visually represented on the display by the workflow management software. Tools are provided for manipulating tickets, such as saving, storing and associating them with documents or compound documents in addition to editing their options. In the preferred embodiments, job tickets can be manipulated just like documents, using pointing, clicking, selecting, dragging and dropping. For example, a job ticket can be associated with a document by selecting the job ticket and dragging and dropping it on a particular document. The workflow management software then preferably visually displays the association by showing the ticket under the hierarchy of the document. Once associated, the options set by the ticket will apply to the associated document or compound document. The options represented by the job ticket may be set by selecting the ticket to bring up a dialog box or pull down option menu, which displays the available options and allows modification of the option values. Job tickets associated with documents can be manipulated with the document. For example, saving a document saves all of its associated tickets. Furthermore, the workflow management software provides the capabilities to create libraries of standardized tickets, which can be used, for example, to standardize procedures across multiple franchised print shops.

Finally, the workflow management software provides tools to send the prepared documents and any associated tickets to the production output device for final production In the preferred embodiments, documents or compound documents can be sent to a production output device by selecting, clicking or dragging the visual representation of the document or compound document to a visual representation of the print server or output device. Alternatively, the user may select an appropriate option from a pull-down menu, pop up dialog box or button palette. The workflow management software supports standard interfaces and protocols to production output devices and print servers. Further, tools are provided for managing, selecting and monitoring multiple production output devices. These tools provide visual feed back of each of the devices status to the user.

According to the present invention the print shop operator first assembles all input (electronic and hardcopy) into a single electronic document at the job preparation station 116. In an exemplary embodiment, the Adobe Acrobat® software program is used to identify the location of the tab sheets using a utility that works with the same application used to assemble the input (e.g. an Acrobat plug-in). This information is stored with the document. Using a utility that works with the same application used to assemble the input, (e.g. an Acrobat plug-in) the tab label information is entered independent from the tab order. This will normally include the text and font. This information is then stored within the document.

The present invention provides flexibility in the process of printing the page numbers on the pages of a document by including either a flag, tag, marker or variable that indicates which pages are going to contain a page number. Additionally, the invention provides information that is going to be rendered on a page. The preferred embodiment places a flag, tag, marker or variable inside a PDF page and stores the PDF page in memory. Placement of data regarding page numbering within the PDF page enables users to move this page around in the document or even copy the page to a different document without introducing page-numbering conflicts. Once the document containing such page numbers is to be printed or saved, a page numbering software module goes to the PDF document and produces the page numbers at the correct locations on the numbered pages.

The present invention envisions multiple embodiments that can accomplish the desired page numbering scheme. The flag, tag, marker or variable that is placed within the page could simply state a Boolean status such as “Apply Page Number to This Page” or “Do Not Apply Page Number to This Page”. It is envisioned that the page number generation would be relegated to separate a software module which controls all page numbers for a given document allowing the user to specify such items as font, right/left/center justification and margins/positional placement of information. At print time, the page number generation module would iterate through the pages of a document, querying whether or not each of the pages was to receive a number. The correct number would then be applied to the page in the correct locations, and with the correct appearance. Therefore, if new pages were added to a document, pages were deleted from a document or pages were moved around, the page numbering would still be correct.

An additional configuration detail that is envisioned by the present invention is a “Display/No Display” attribute. Using the “Display/No Display” attribute, a user could “hide” the page number if desired. The page number counter would still be incremented, but no number would be displayed.

The flag, marker, tag or variable as envisioned by the invention, is not necessarily simply as a Boolean status, the invention specifically envisions alterable page content. The flag, tag, marker or variable can comprise a page number location, formatting attributes, and the side of a page (front or back) the page numbers printed on. These can include, but are not limited to, the positioning of the page number, the font of the page number, or format of the string that is to be used for the page number. It will be readily understood by those skilled in the art that the print production systems of the type previously described are sophisticated pieces of equipment and that these systems have the computational power and graphical user interfaces necessary to provide the user with the ability to enter and control the foregoing types of information. The entering of information is preferably done at the document level, thereby affecting all the pages of the document. However, it is specifically envisioned that the individual pages can retain their own characteristics. The preferred embodiment of the invention provides, at one point in the graphical user interface, the ability to specify the page numbering attributes for each individual page.

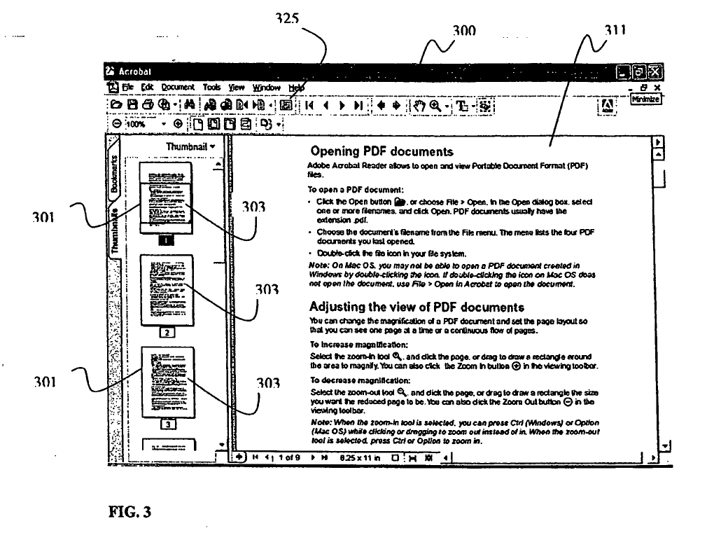

Referring to FIG. 3, which is an Acrobat® screen 300 that allows a viewing of the screen divided into two portions, commonly known as “split pane”. The “split pane” view allows the viewing of both the thumbnails 301 of all the individual pages 303 within the document in one pane on the left, while providing a separate view of the document 311 in another pane 313 on the right. Using the viewing screen as provided by Acrobat®, it is possible without changing pages, to scroll up and down within the current page to view thumbnails of all the different pages within the document. This allows the user to preview the various pages within a document and to select individual pages within the document to apply page attributes to those pages. Using this mechanism, the user can select a set of pages that are not to receive page numbers. This selection process is preferably accomplished using a typical Acrobat® screen as shown in FIG. 3. However, it will be readily apparent to those persons skilled in the art that other solutions not using Acrobat® are also achievable. Acrobat® is a widely available platform. However, the invention envisions that similar results can be achieved using other formats including proprietary solutions.

The Applications Programming Interface (API) for Acrobat® provides a mechanism that allows the addition of menu items. The present invention envisions employing an Acrobat® plug-in as an additional menu item. The invention uses a drop-down menu to allow selection of those pages that will not receive page numbers, text or graphics printed on them. Preferably, the user reviews the document and tags any individual pages that are not to receive a page number. In the preferred embodiment, the drop-down menu is provided as an Acrobat® plug-in. The foregoing process allows the user to apply page level features, for example, tab stock that is not to receive page numbers. The invention, thus, effectively provides a catalog for the pages of the document simply by using Adobe Acrobat®. The plug-in features of the invention also allow the use of a dialog with menu features.

As an example, assume that a document is received by a printer and is to be printed as a duplex document having cut tabs separating various sections of the document. The document may be received by the printer without any cut tabs. In that case, the user opens Adobe Acrobat® and uses the pull down menu that is provided by the plug-in of the invention. The dialog box for the plug-in of the invention is then selected and the user selects any pages (in this case presumably tab stock) that will not receive page numbers. The dialog box can be selected by simply clicking on an icon to present the page numbering dialog box. The dialog box can also contain a font preference, that allows specifying the type and size of the text used for the page number. Another attribute that would typically be specified within the dialog box would be the placement of the page number on the page. The present invention supplies information related to page numbering on a page within the document as part of a PDF page within memory.

The page numbering scheme of the invention may be a step within the workflow that occurs at a similar point within the workflow (preferably just after) as the information related to pre-collated media, like tab stock. The user then initiates a printing phase (or other initiation process) and the page numbers are inserted into the document. The result is page content with special pages added and correct numbering of pages. The application of page numbers onto pages in a document is then simply a step within the workflow process. By making the application of page numbers part of the workflow process, the user can select pages that will not receive page numbers. Another option is to configure preference for certain media types that are never to receive page numbers, such as a list of media types for which the printing system is knowledgeable. For example, the media type LetterTab could be selected never to receive page numbers, or the user can simply select any of the cut tab stock used within a document that is not to receive page numbers as previously described. The invention envisions supplying templates as general user preferences, these templates have certain items that can be selected by the user, for example, to select the media type LetterTab to never receives page numbers, the user would only have to select the template for the media type LetterTab. Another mechanism to determine if a page should have a page number applied is to evaluate the page content and page meta information so that only pages that actually contain tab information will not receive page numbers.

Flexibility within printing is desirable. For instance, if the front cover to a document will be printed using the same media type as the rest the document, it would probably be desirable not to apply a page number to the front cover. The invention provides the ability to review thumbnails of all pages within a document and select those pages that will not receive page numbers. This yields the desired flexibility and the user can select those pages that are not to get a page number. Those selected pages would be tagged, flagged or marked to identify that they are not to receive a page number. At that point the user is done, except possibly for previewing the document. If the user decides to skip the preview mode, then the system software would embed the page numbers on the pages. The document with the embedded page numbers can be sent to the printer and every page would be sent in PDF format. All special tags, flags, variables or markers are removed from each page in the PDF format. This is the late binding within the workflow that occurs just before the document is sent to a printer, or saved to be routed to a specific destination where it can be printed at a later time. Everything that is required for that print job to be printed, is embedded within that single PDF file. Placing all elements for the print job into a single PDF file in this manner creates a print job that is completely portable. This has inherent advantages over prior art solutions. A common prior art solution is to create a separate TIFF file for each individual page of a print job. Therefore, if the document has 300 pages, then 300 separate TIFF files would have to be created. Distinguishing from these prior art systems, the present invention provides the entire print job in a single PDF file that is completely portable and is easy to share.

The merging of attributes is an important feature within commercial printing systems. Merging of attributes involves attributes from separate files in those instances when the separate files are to be combined. As an example, once a system is in place, a document containing smart stamped content could be inserted into another document that also has smart stamped content. For example, the font or position attributes of the page numbers in the two documents might be different, or might contain different watermarks. Using this functionality, it would be possible to automatically update the attributes of the stamped page content of the inserted document so that everything will be consistent in the combined document.

Merged documents may have sustained content added to them. One might say page X and the other might say page X of Y, depending upon how the page number is formatted. One of the powerful things about Acrobat® is that two documents can be opened and portions of the two documents can be merged together. Assume for example, that a first person is in the process of writing and that a second person has already written a report having certain portions that the first person wishes to refer to in an appendix. It would be desirable to open both documents simultaneously so that portions of the two documents can be drawn together and placed into a single document. A potential problem exists if the two documents have different formats. The present invention provides the ability to recognize the dynamic stamped content contained within these different documents and alert the user that the formats are in conflict or are different. PDF is a powerful format that allows the provision of information at two different levels. Within the context of the present invention, one of these levels would be the document level having information pertaining to the entire document. PDF also allows information at the page level regarding each page's individual attributes. Therefore, PDF allows the user to take a page from a first document and pull it into another document and retain the page specific content for that page. The invention provides optional controls at both page and a global level. Thus, the invention retains page specific content when inserting pages from one document into another thereby allowing a user to move a page into a different document and still retain their original attributes. The moved page would not acquire the global characteristics of the document that it was moved into, but would instead retain its original characteristics.

In printing using tab stock there are two overall considerations. First, tab stock may extend beyond normal boundaries of the paper that is used in the document. It is the tab that is the portion of the tab stock is going to be written on. Second, one has to determine when to draw tab stock and insert it into the document. Most commonly, the pages of tab stock that are inserted in a document cannot receive page numbers. Moreover, if the tab stock is not to receive a page number the tab stock also should not consume a page number. The present invention allows designating a page of tab stock as if it was a regular page, in which case the page number is printed on a piece of tab stock. The present invention also allows for text to be printed on tab stock. If a page of tab stock is going to be printed on, it is usually desirable to have the page number printed on that page. The present invention extends the option of placing page numbers on tab stock to insert types of media. For instance, the invention allows a user to print on a cover sheet on the front of the document, or other types of inserts can also be printed on. The present invention accomplishes this by placing a flag, marker, tag or variable on every page that allows the system to respond in an intelligent manner.

In order to leave selected pages unnumbered, the user interface of the present invention provides a mechanism to indicate that certain pages (such as tabs) should be left unnumbered. Alternatively, if a page has previously been designated to be unnumbered, the present invention removes such designation.

In a preview mode, the user can provide an indication of the content that will be added automatically to certain areas of the document. For example, certain pages are not to receive page numbers, the invention allows the user an electronic view of the document. For large documents, it may not be desirable to display the actual page numbers in the preview mode. Taking into account the job and page features that will be applied in the printed document could be computationally intensive. Taking all of these things into account and displaying them in real-time as the document is viewed might introduce an undesirable performance penalty. Therefore, the invention provides a computer readable indicia on the page indicating that “a page number” will be applied here or “a header” will be applied here. These annotations preferably take the form of a text box, a shaded box or some placeholder text.

In the preview mode, the user performs a soft proof of the document before it is printed in order to prevent the potential waste of media. By placing some kind of computer recognizable indicia such as a flag, marker, variable or tag on each page for pagination purposes, the invention provides inherent options within the preview mode. One of these options is to view page numbers, another option is to not have the page numbers displayed in the preview mode. In either case, it is the use of the flag, mark or tag that allows the invention to provide this option.

One page numbering style commonly used in books is to always place the numbers on the unbound edge of the page, referred to herein, as Books Style Page Numbers. In this scenario, odd numbered pages have the page number on the right, and even numbered pages have the number on the left. For simple documents, this is straightforward. However, another common style used in the creation of complex documents is to force the first page of each major section or chapter of a document to appear on the front of the page. The insertion of chapters as sections (or insertions such as tabs), cause blank pages to be added to the back of the last page sections containing odd numbered pages.

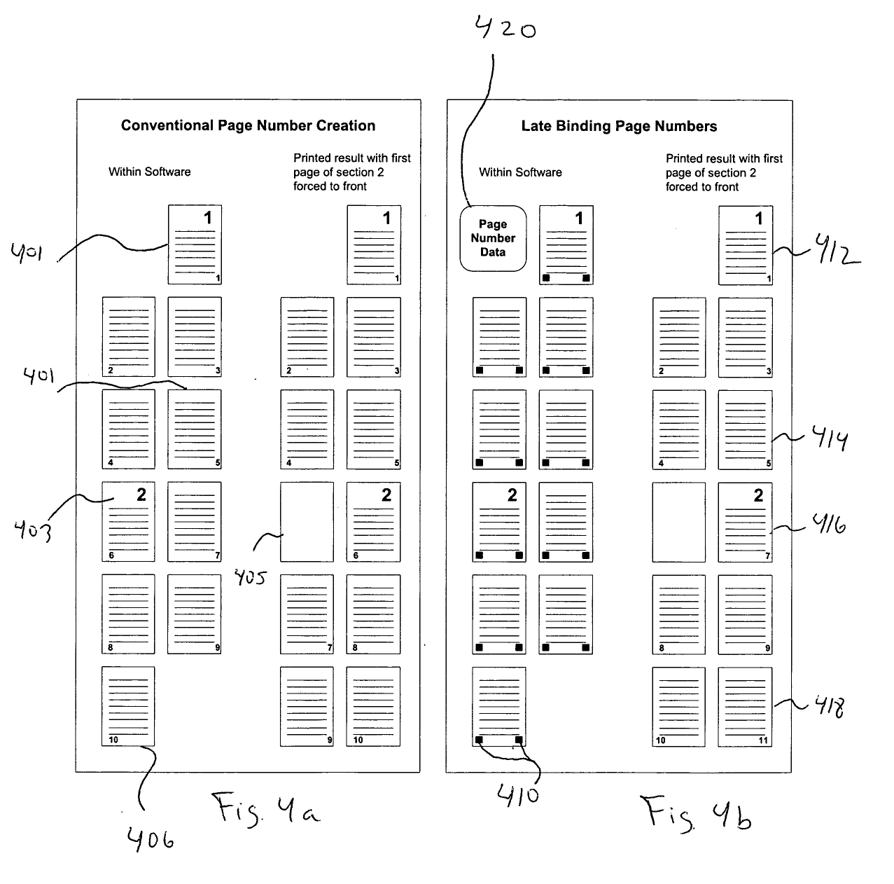

For example, assume a 10 page document is divided into two sections as illustrated in FIG. 4a. There are shown six physical pages (401-406) with printing on one side of the first and last page and on both sides of the other pages. It illustrates a conventional method for page number creation. Section 1 has 5 pages 401 which means that page 6 will appear on the back of the third physical sheet 403 of the document. If instructions are inserted into the print stream that page 6 is to be on the front of the page, a new blank page image 405 is inserted by the printer into the document on the back of page 5. If the system does not take into account that the page numbers are to be applied to the “outside edge” of the document, then the page numbering scheme will be thrown off. On the left side of FIG. 4a, a virtual representation is shown of the various pages in Sections 1 and 2 as they exist in software. In software, page 10 appears to be the front side of the sixth physical sheet 406. It is clearly evident, that the page numbers have already been “stamped” onto the various pages while the pages are still within software, the page numbers within software are in their intended position. However, when a blank page 405 is inserted, the page numbers are no longer in their intended position. See the right-hand side of FIG. 4a. The present invention corrects this problem by not applying page numbers to the pages until late in the workflow process. Using conventional techniques illustrated in FIG. 4a, the page numbers end up in the bound edge in Section 2 due to the introduction of a new blank page 405 at the end of Section 1. This forces the first page of the second section to be on the front of a physical sheet.

FIG. 4b illustrates the late binding page numbering as envisioned by the present invention. It shows page number data 420 that provides an intelligent page numbering scheme that works with the document's job ticket to understand the page plex and page exceptions. Based on this added data, print systems can correctly determine where the unbound edge would appear in the printed document, and correctly assign a page number, in the correct location. In the late binding paradigm illustrated in FIG. 4b, it is not necessarily known exactly where the page numbers were going to be placed at all times if job and page level features are not dynamically accounted for. However, it can at least be indicated in which areas content is expected to be placed. FIG. 4b in the above example includes shaded boxes 410 that are the potential locations for page numbers. There are multiple locations shown by shaded boxes 410, because the actual location of the unbound edge is treated as an unknown. Only after a save, a print or a user request, does it become known where the unbound edges are. The page numbers are then determined and the shaded rectangles are replaced with actual page content. The result is that the printed document has its page numbers in their intended position. The first section has the same page numbering as in FIG. 4a, which can be seen from Page 1 which is the frontside of the first physical sheet 412 to Page 5 which is the frontside of the third physical sheet 414. However, the second section shown to FIG. 4b is a page numbering scheme that is entirely different from that of FIG. 4a. Section 2 in FIG. 4b has the frontside of the fourth physical sheet 416 with the page number 7. The odd page numbers continue on the frontside of all the physical sheets until page 11, which is the front side of the sixth physical sheet 418. This makes forcing chapter pages on the front side convenient. It is to be noted that the present invention provides the flexibility to with print or not print the page number 6 on the otherwise blank sheet. FIG. 4b shows the number printed.

It is common in printing books using Books style Page numbers to have pages printed on both front and back and have page numbers on outside corners. On the front side of a page, the page number will be on the lower right side of the page. On the backside of a page, the page numbers will be on the lower left. Currently existing software packages can determine the correct placement of page numbers in an alternate fashion from lower left to lower right. However problems are created if there is a change in that simple page numbering scheme. For example, if a different type of media that does not receive page number is inserted into the document, it causes errors in the page numbering scheme. This is especially true in cases where the inserted media has a single side that is printed on and, therefore, counts as a page. The present invention solves this problem by using flags, tags, variables or markers on each page to indicate the correct plex for each side of every page that is used, allowing for each page number to be correctly identified and printed.

Another style of page numbering that is commonly used to allow more than just a simple “number”, is referred to as Formatted Page Numbers that provides for formatting before and after the page number. Examples include, but are not limited to, “Page 2 of 37” or “-2-”. The formatting of page numbers can easily be accomplished using the present invention tool by providing the necessary text fields in the data entry area. A variable syntax such as “% N” for page number and “% T”for total number of pages could be used to dynamically fill the numeric data.

Portability of electronic versions of documents is an asset that has not been effectively utilized by prior art solutions. The present invention creates documents that are very portable by placing flags, tags, markers, or variables on individual pages within a PDF document, indicating that these pages should receive page numbers. The PDF document itself does not have visible page numbers, and the document will not have visible page numbers until the PDF document is processed by the page numbering module to create actual page numbers on a page. Once the page numbering module creates visible page numbers, the document becomes “unportable”, because of the proprietary nature of the page numbering module. If the document were accessed by a printing system that did not have a compatible page numbering module, the page numbers would not show up. For this reason, the invention envisions the desirability of a proprietary page numbering module that can generate actual page numbers in at least three ways: 1) in the background at print time; 2) when the document is saved; and 3) when the user requests it. The page numbers could, therefore, be generated not only when the document is printed, but also whenever the document is saved. If the user was very interested in the specific application of the page numbers, the user can request that the page numbers be generated. This requires a slight delay while the page numbers are being applied. If the page numbers were periodically bound to the page, as described above, the electronic version of the document would still remain portable. The page numbers would remain in place until the document was changed in such a way that a conflict is introduced (such as the addition of a page or movement of the page within the document). At this point all page numbers would automatically be stripped and a document would go back into the “preview” state until the page numbers were once again committed.

The invention maintains page numbers that are placed within documents. Unlike page numbers they were created in an external authoring application (such as Microsoft Word) or were received from a scanned hardcopy, page numbers created by the page numbering module of the invention can be flagged so that it is known that the page numbering module of the invention was used to create the page numbers. This allows the page numbers to be removed in the future, if at a later date it was desirable to “repurpose” or update the document and renumber those pages. This would effectively allow the user to “undo” the previous decision to commit to an actual page numbering of each page.

Headers, footers and watermarks create flexibility issues within production printing systems. There flexibility issues exist within prior art solutions that create PDF “stamps”. Many tools (such as StampPDF® from Appligent Inc.) allow users to add text to PDF documents to be used as a header, footer or watermark. However, these stamps become static PDF objects and do not update when the document changes. For example, assume the user applies a watermark to the document (a large textual annotation across the body of the document) that reads ROUGH DRAFT, to “FINAL DRAFT” or some other user-defined state. If new pages were later added to the document, prior art solutions do not provide any method for these newly added pages to automatically inherit the watermark. A late binding stamping mechanism could delay the actual application of the stamp until print time, the same as with page numbers or tab text. Users could designate certain pages to receive the stamp (this would be the default perhaps) and also designate pages they should not receive the stamp (such as tabs).

The application of the invention to headers, footers and watermarks illustrates that the invention is not limited to page numbers, but is also applicable to page content. Currently available software applications allow the user to “stamp” either text or graphics onto a page, such as a watermark. Therefore, if it is desired to have each page of a document have the stamp of either CONFIDENTIAL, or possibly DRAFT, this could be accomplished. In the case of DRAFT documents, the same document that was originally marked DRAFT, could very well be reissued without the stamp of DRAFT on the. Therefore, it is desirable to remove the DRAFT watermark and replace it with a watermark that states FINAL. Using the flag, marker, tags or variable as envisioned by the present invention, it is possible to keep track of a header, footer or watermark and review the text that is contained therein and modify it accordingly. The invention allows editing of these items. The present invention does not treat these items as static stamps, but instead as a modifiable item that can be altered.

Instead of creating “stamps” of text that provide no intelligence or knowledge about a document, it is possible to designate specific fields such as header, footer, watermark and page number. The invention provides text fields that can be committed to a specific purpose which allows assumptions to be made regarding the behavior of the document. These assumptions are valuable to the end customer in terms of time savings and ease-of-use.

The foregoing description provides the embodiments best known to the inventors, variations of these embodiments will be readily apparent to those skilled in the art, therefore, the scope of the invention should be measured by the appended claims.

1. A printing system for placing content within a document comprising:
a computational element coupled to a user interface;
a routine, within the computational element, that allows entry of a computer readable indicia into an electronic version of the document for a specific type of content that is to be applied to a set of pages within the document; and
a module within the computational element that applies the specific set content to the set of pages.

2. The printing system of claim 1, wherein the computer readable indicia further comprises either a flag, a tag, a marker or a variable that is placed into the electronic version of the document to indicate which of the set of pages are to receive the specific type of content.

3. The printing system of claim 2 wherein the flag, a tag, a marker or a variable is placed on every piece of media within the document.

4. The printing system of claim 3, wherein the set of pages further comprises a subset of all pages within the document.

5. The printing system of claim 4, wherein the specific type of content further comprises a page number.

6. The printing system of claim 5, wherein the specific type of content further comprises the placement of the page number on each page from the document.

7. The printing system of claim 5, wherein the specific content further comprises a font type for the page number.

8. The printing system of claim 4, wherein the specific type of content further comprises either a graphic, a header, a footer or a watermark.

9. The printing system of claim 1, wherein the routine allows entry of the indicia to indicate which pages of a least one set of pre-collated media are to receive the specific content.

10. The printing system of claim 9, wherein the module further comprises a determination of pages that will receive the specific content, and the determination of pages including multiple iterations by the routine that adds new pages to the electronic version of the document.

11. A method for placing content within a document comprising the steps of:
providing a print job for a document defined by an electronic format;
entering into the electronic format a computer readable indicia that identifies a specific type of content and a set of pages on which the specific type of content is to be placed, and
processing the electronic format by interpreting the computer readable indicia as it applies for each page within the document.

12. The method of claim 11, wherein the step of entering further comprises placing either a flag, tag, marker or a variable as the computer readable indicia on each page of the electronic format.

13. The method of claim 11, wherein the step of processing further comprises selecting the set pages that the specific type of content is to be placed on.

14. The method of claim 11, wherein the step of entering further comprises the step of iteratively editing the electronic version of the document to include at least one different media type played with the computer readable indicia.

15. The method of claim 14, wherein the step of processing further comprises responding to the step of iteratively editing to place the specific content on pages in accordance with the indicia that has been placed on the different media types.

16. The method of claim 11, wherein the step of providing further comprises electronic format being a graphical language.

17. The method of claim 16, wherein the step of providing further comprises the graphical language being PDF.

18. A method for placing content within a document comprising the steps of:
providing a print job for a document defined by an electronic format;
entering into the electronic format a computer readable indicia that identifies a specific type of content and a set of pages on which the specific type of content is to be placed, and
processing the electronic format by interpreting the computer readable indicia as it applies for each page within the document;
altering the computer readable indicia; and,
processing the electronic format by interpreting the computer readable indicia as it applies for each page within the document.

19. The method of claim 18, wherein altering comprises removing content from certain pages.

20. The method of claim 18, wherein altering comprises removing page numbers and the processing comprises recalculating the page numbers.

21. The method of claim 18, wherein processing comprises recalculating the page numbers.

22. The method of claim 18, wherein processing comprises not printing page content.
